(19) United States
(12) Patent Application Publication
(10) Pub. No.: US 2022/0015492 A1
(43) Pub. Date: Jan. 20, 2022

(54) METHOD FOR FABRICATING STRENGTHENED PLASTIC SHELL OF SAFETY HELMET AND HELMET STRUCTURE FABRICATED USING THE SAME

(71) Applicant: CHANG-HSIEN HO, TAINAN CITY (TW)

(72) Inventor: CHANG-HSIEN HO, TAINAN CITY (TW)

(21) Appl. No.: 17/069,086

(22) Filed: Oct. 13, 2020

(30) Foreign Application Priority Data
Jul. 16, 2020 (TW) 109124135

(51) Int. Cl. A42C 2/00; A42B 3/06; A42B 3/12; B32B 27/12

(52) U.S. Cl. CPC A42C 2/005; A42B 3/063; B32B 2437/04; A42B 3/125; B32B 27/12; A42C 2/002

(57) ABSTRACT

A method for fabricating a strengthened plastic shell of a safety helmet and a helmet structure fabricated using the method are disclosed. The method includes providing at least one fiber layer and at least one shell that has a thin, flat structure; binding the fiber layer to the shell to form a preform; heating and pressing the preform with a first forming module, so that at least some local, surface texture of the shell is fused with or interlaced with the fiber layer to form an assembly that has a helmet-like shape (or contour); and arranging a foam material at an inner surface of the assembly and attaching the foam material over the inner surface of the assembly using a second forming module, thereby forming a helmet structure. The method makes the overall fabrication less complicated and less time-consuming as compared to the prior art.

### BACKGROUND OF THE INVENTION

### 1. Technical Field

The present invention relates to a method for fabricating a strengthened plastic shell of a safety helmet and a helmet structure fabricated using the method. The present invention processes a combination of a fiber layer (or a fabric) and a shell that has a flat structure with a forming module to bind the fiber layer and the shell together.

### 2. Description of Related Art

A safety helmet, also known as a crash helmet, which has a plastic shell firmly bonded with an impact-resistant filler made by heating a foam material is commonly used as protective equipment for ball games and riding sports and its fabrication is known in the art. Some prior-art patents, such as U.S. Pat. No. 4,466,138 related to a safety helmet with a shell injected from thermoplastics and method for the manufacture of said safety helmet is a typical example.

Structurally, such a safety helmet uses the outer plastic shell to resist piercing impact from an external object, and uses the foam filler to buff by distributing the impact force over the foam filler, thereby protecting the head of its wearer.

With respect to fabrication of such a safety helmet, an issue to be addressed is that, for adding visual quality or attraction, a plurality of colored graphic it is a common practice to apply or attach patterns or fabric patches (such as 6˜8 pieces) to the outer surface of the helmet. During fabrication, the graphic piece or the fabric material is applied and adhered to the entire or partial surface of formed plastic shell, as known to people skilled in the art. Fabrication of the foregoing helmet structure is subject to the following concerns:

1. Adheresion of the graphic piece(s) or the fabric material requires skilled workers because the graphic pasters or fabric patches have to be preciously adhered to specified areas or regions of the surface of the helmet as designed surface. An unskilled worker can cause the graphic piece or the fabric material to be adhered with unevenness or creases at, particularly, edges of the graphic piece or the fabric material.

To be specific, for maximizing smoothness of the adhered graphic or fabric piece(s) on the surface of the plastic shell, it is necessary to press and spread the graphic or fabric piece(s) over the surface of the plastic shell from center to edge. In this process, an unskilled worker can easily end with misalignment or mismatch between some edges of the graphic piece(s) or fabric and the contour of the plastic shell (or the specified site(s) with respect to the contour of the plastic shell).

This is particularly obvious when the applied pasters or fabric are with elasticity. When correcting such misalignment or mismatch, the worker has to spend additional time while paying extra attention to prevent the correction from damaging those parts that are already well applied or adhered. It is thus clear that the conventional fabrication or processing is not only skill-demanding but also time-consuming.

2. While the graphic pieces or fabric are usually precisely sized and shaped to minimize the foregoing misalignment or mismatch between some edges of the graphic piece(s) or fabric and the contour of the plastic shell (or the specified site(s) with respect to the contour of the plastic shell), perfect adhesion of graphic or fabric piece(s) with elasticity is relatively difficult to achieve.

3. In the event that the worker performing the adhesion operation is not skilled enough, unevenness or creases are more likely to appear at edges of the graphic or fabric piece(s) and the adhesive is more likely to be smeared around the surface of the plastic shell.

In addition, adhesion the graphic or fabric piece(s) is highly dependent on manual operation even in manufacturing scenarios and cannot be performed mechanically. This means the manufacturers need to overcome the difficulty in recruiting a large number of skilled workers or the quality of their products is hard to control.

Representatively, the foregoing references prove that the current approaches to design and fabrication of helmet structures are yet imperfect. It is thus desirable to redesign the configuration of a safety helmet so that improved fabrication or processing practices are applicable thereto. Such a redesigned configuration shall also address the shortcomings of the prior art. In other words, when trying to address or overcome the previously discussed problems, we have to think about the following design issues in terms of both construction and composition:

1. Operations and structures different from those known in the prior art shall be employed to ensure that a safety helmet has a texture structure that meets applicable safety requirements while allowing the fabrication to be simplified and the resulting helmet to be lightweight.

2. The improved fabrication method shall minimize misalignment or uneven fit between the edge of the graphic piece or the fabric material and the contour of the plastic shell, thereby eliminating the problems of the conventional safety helmets about time-consuming processing or fabrication, high demands for skilled workers, and high defective loss.

3. Particularly, the proposed method shall make the fiber layer (such as the graphic piece or the fabric material) such tensioned that when the shell is impacted by an external force, an elastic counterforce or resilience is generated.

### SUMMARY OF THE INVENTION

Hence, the primary objective of the present invention is to provide a method for fabricating a strengthened plastic shell of a safety helmet, comprising the following processes.

A process A involves providing at least one fiber layer and at least one shell, wherein the shell is made of plastic, PC or the like and has a thin, flat structure.

A process B, also referred to as a binding operation, involves binding the fiber layer to the shell to form (or define) a preform.

A process C, also referred to as a forming operation, involves heating and pressing the preform with a first forming module, so that at least some local, surface texture of the shell is fused with or interlaced with the fiber layer to make the preform bonded and united, and thereby forming an assembly that has a helmet-like shape (or contour).

According to the disclosed method for fabricating a strengthened plastic shell of a safety helmet, the process C is followed by a process D, also referred to as a foam attaching operation, involves arranging a foam material at an inner surface of the assembly and foaming the foam material into an elastic structure attached over the inner surface of the assembly using a second forming module, thereby forming a helmet structure. The present invention makes resulting helmet structurally strengthened and lightweight while making the overall fabrication less complicated and less time-consuming as compared to the prior art.

The helmet structure made using the previously described method according to the present invention comprises a combination of the shell and the fiber layer deposited on the shell, wherein the shell has at least its local, surface texture interlaced within the fiber layer so that the shell and the fiber layer are bonded and united to make the fiber layer tensioned against the (surface) contour of the shell. As a result, when the shell is impacted by an external force, the fiber layer (as well as the shell) generates an elastic counterforce or resilience.

### BRIEF DESCRIPTION OF THE DRAWINGS

FIG. 1 is a schematic illustration of a process A of the present invention, showing a fiber layer and a shell (or a thin, flat structure);

FIG. 2 is a schematic illustration of a process B of the present invention, showing the fiber layer attached to the shell to form a preform;

FIG. 3 is a schematic illustration of a process C of the present invention, showing the preform being processed into a helmet-shaped assembly by a first forming module;

FIG. 4 is a cross-sectional view of the structure of the assembly, showing surface texture of the shell fused into or interlaced with the fiber layer;

FIG. 5 is a schematic illustration of a process D of the present invention, showing the assembly and a foam material made into a helmet structure by a second forming module;

FIG. 6 is an applied view of the helmet structure in one operational embodiment of the present invention, showing the helmet structure or the assembly impacted by an external impact force (or a normal force); and

FIG. 7 is an applied view of the helmet structure in another operational embodiment of the present invention, showing the helmet structure or the assembly impacted by an angled impact force (or a shear force).

### DETAILED DESCRIPTION OF THE INVENTION

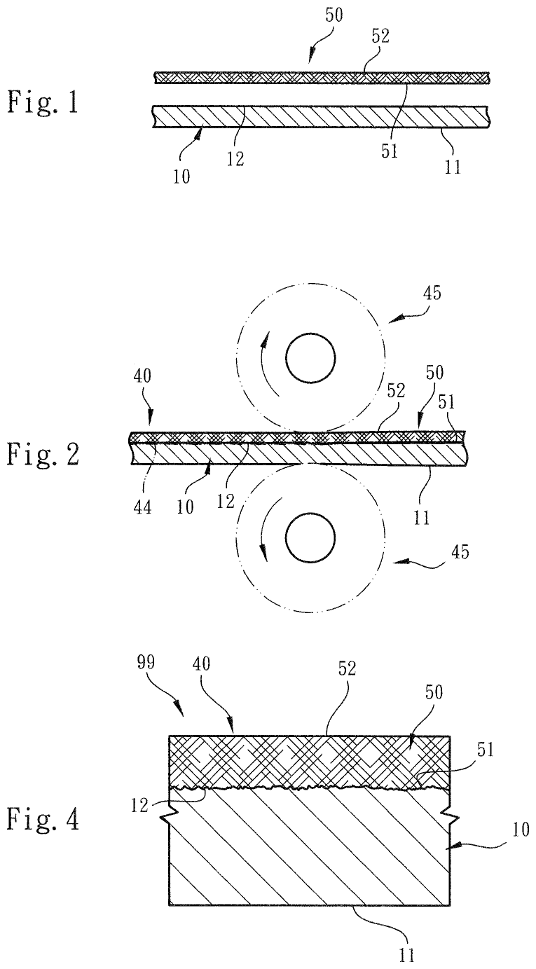

Referring to FIG. 1, the disclosed method for fabricating a strengthened plastic shell of a safety helmet is described with reference to a safety helmet for sports use as an embodiment. The safety helmet may be a football helmet, a hockey helmet, a construction helmet, a hiking helmet, or a full-face or half-cover helmet for horse riding, bicycle riding, motorcycle riding, skiing, car racing, etc.

In the description below, the terms “upper,” “top,” “lower,” “bottom,” “outer” and “inner” are all referred to the orientation of the subject matter shown in the relevant drawing. For example, a part of the disclosed helmet facing its wearer is herein defined as the first side (or the inner side or the inside), and a part opposite to or away from the wearer is defined as the second side (or the outer side or the outside).

Referring to FIGS. 1, 2 and 3, the method for fabricating a safety helmet comprises the following processes.

A process A involves providing at least one fiber layer 50 and at least one shell 10. The fiber layer 50 is made of cloth, fabric or the like in the illustrated embodiment. The shell 10 is made of plastic, PC or the like, and has a flat structure.

As shown, each of the fiber layer 50 and the shell 10 defines or has a first side 51 or 11 and a second side 52 or 12. In a feasible embodiment, the fiber layer 50 is made by putting a plurality of fiber pieces together into the complete fiber layer 50.

A process B, also referred to as a binding operation, involves binding the fiber layer 50 (or the first side 51 of the fiber layer) to the shell 10 which is a flat structure (or the second side 12 of the shell 10) to form a preform 40.

In a feasible embodiment, imaginary circles in FIG. 2 indicate a module 45 (such as a pair of rollers) pressing the fiber layer 50 against the shell 10 to attach the fiber layer 50 to the shell 10 firmly. Additionally, a layer of adhesive 44 (as indicated by the imaginary line in the middle of the drawing) may be arranged between the fiber layer 50 (or the first side 51 of the fiber layer) and the shell 10 (or the second side 12 of the shell) to make the fiber layer 50 batter attached to the shell 10.

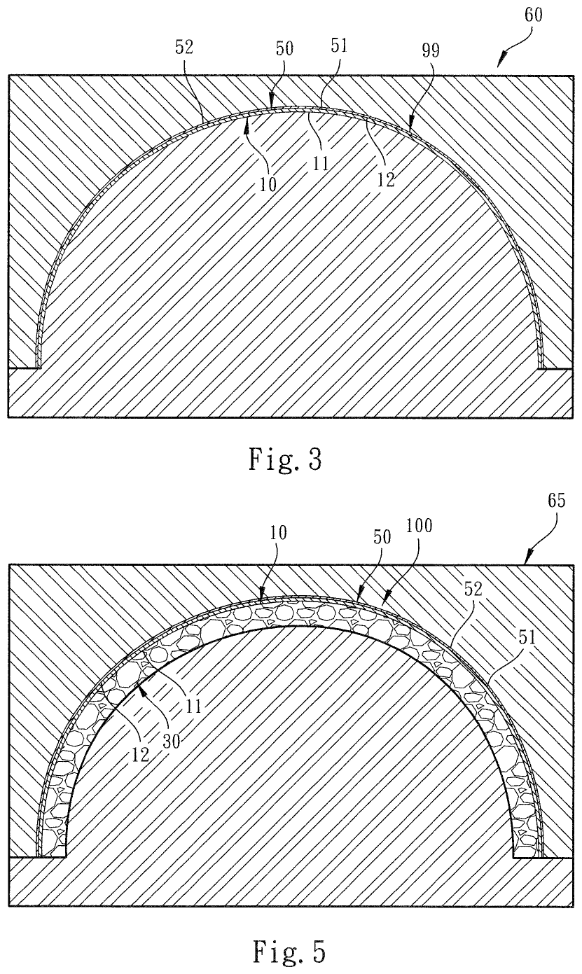

FIG. 3 illustrates a process C, also referred to as a forming operation. The forming operation involves heating and pressing the preform 40 with a first forming module 60 to make the preform 40 into an assembly 99 that has a helmet-like shape (or contour). The fiber layer 50 also acts as a protective layer and may provide diverse decorative effects with graphics and/or texts.

FIG. 4 discloses the operation of the process C. The shell 10 (or the second side 12 of the shell) has at least its local, surface texture fused into or interlaced with the fiber layer 50 (or the first side 51 of the fiber layer) to form (or define) a bonded, united structure. As a result of the texture structure of the shell 10 (at the second side 12) getting interlaced with the fiber layer 50, the structural texture of the fiber layer 50 is slightly expanded. Thus, the fiber layer 50 is tensioned against the (surface) contour of the shell 10, so that when the shell 10 is impacted by an external force, the fiber layer 50 (as well as the shell 10) generates an elastic counterforce or resilience.

Particularly, the process C further involves endowing the shell 10 (and/or the fiber layer 50) with a curved contour that is required by the final safety helmet, and facilitating the fiber layer 50 getting tensioned against (or getting close fit with) the shell 10 as described above. This effectively addresses the problems of the conventional manual adhesion about generation of creases and time-consuming operation, while structurally strengthening the resulting shell.

It is to be understood that the combined configuration of the fiber layer 50 and the shell 10 as described in the previous embodiment benefits by the complementary structural strength of the two parts and provides the possibility to further reduce the thickness of the shell 10 and in turn reduce the weight and volume of the final helmet. For example, the shell 10 may be made of a plate (not film) as thin as 0.5 mm˜2.0 mm.

Referring to FIG. 5, a process D is also referred to a foam attaching operation. The foam attaching operation involves arranging a (solid-state) foam material at an inner surface of the assembly 99 and heating and foaming the foam material (into an elastic structure 30) attached over the inner surface of the assembly 99 using a second forming module 65, thereby forming a helmet structure 100. The present invention makes resulting helmet structurally strengthened and lightweight while making the overall fabrication less complicated and less time-consuming as compared to the prior art.

A helmet structure made using the disclosed method for fabricating a strengthened plastic shell of a safety helmet includes a combination of a shell 10 and a fiber layer 50 deposited outside the shell 10 (i.e. on the second side 12). The shell 10 has at least its local surface texture (or the texture of the second side 12) fused into or interlaced with the fiber layer 50, so as to form the aforementioned bonded, united structure, wherein the fiber layer 50 is tensioned against the (surface) contour of the shell 10, so that when the shell 10 is impacted by an external force, the fiber layer 50 (as well as the shell 10) generates an elastic counterforce or resilience.

In an amended embodiment, an elastic structure 30 made of a foam material is attached to the first side 11 (or the inner surface) of the shell 10, so as to form the helmet structure 100.

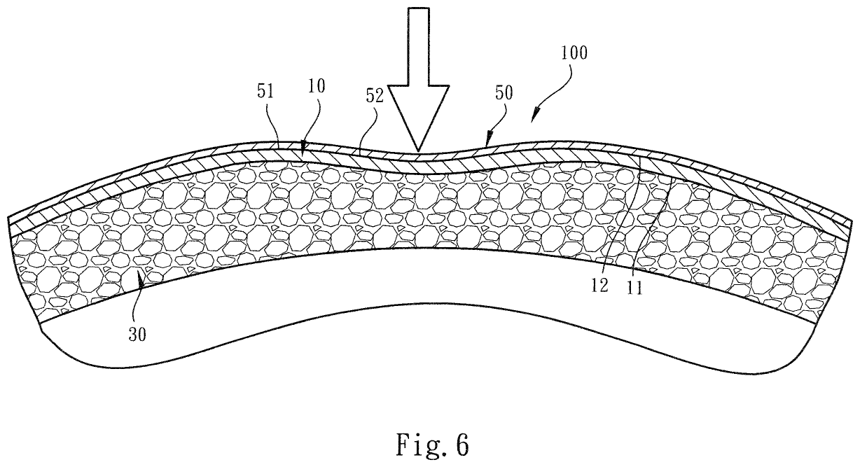

Referring to FIG. 6, when the assembly 99 or the helmet structure 100 is impacted by an external force (or a normal force), the shell 10, the elastic structure 30 and/or the fiber layer 50 generate different elastic deformation amounts to decelerate the external impact force and jointly bear the external impact force, so as to provide buffering and shock-absorbing effects by distributing the external impact force over the entire assembly 99 or helmet structure 100, thereby preventing the external impact force from passing through the assembly 99 or the helmet structure 100, and in turn mitigating potential brain injury or eliminating the risk of such injury.

When the external impact force disappears, the elastic structure 30 and/or and the tensioned fiber layer 50 use their elasticity (or resilience) to work with the structural characteristics to shell 10 to return the structural characteristics to its initial position as much as possible.

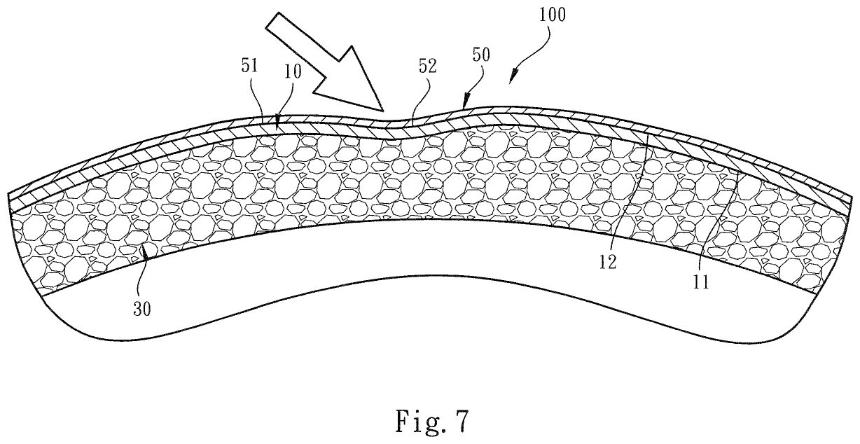

Referring to FIG. 7, when the assembly 99 or the helmet structure 100 is impacted by an external impact force (or a shear force), the shell 10, the elastic structure 30 and/or the fiber layer 50 generate different elastic deformation amounts to jointly bear the external impact force and provide buffering and shock-absorbing effects, thereby reducing the displacement caused by the rotation acceleration or lateral rotary component (including a low-gravity rotary impact force) of the external impact component. The resulting shock is distributed over the entire assembly 99 or helmet structure 100 and gets buffered and absorbed, so the acceleration and torque caused by the external impact force are reduced, thereby mitigating potential brain injury or eliminating the risk of such injury.

Furthermore, when the external impact force disappears, the elastic structure 30 and/or and the tensioned fiber layer 50 use their elasticity (or resilience) to work with the structural characteristics to shell 10 to return the structural characteristics to its initial position as much as possible.

As compared to the plastic shell structure of a conventional safety helmet, the combination of the shell 10 and the fiber layer 50 according to the present invention endows the shell 10 with better elasticity and makes the shell 10, the elastic structure 30 and/or the assembly 99 more structurally capable of enduring the external impact force.

Representatively, the disclosed method and helmet structure feature the following advantages and considerations as compared to the prior art:

1. The combined configured of the shell 10, the fiber layer 50 (and/or the elastic structure 30) is redesigned to have reliable bonds between the fiber layer 50 and the shell 10 using, for example, the foregoing operations A˜C (and/or the operation D), making the preform 40 firm and stable. This allows the fabrication to be realized easily and rapidly without the problems of the conventional fabrication and processing, and allows the resulting helmet structure to be different from the conventional helmets.

2. When the shell 10 has at least its local part fused into or interlaced with the structural texture of the fiber layer 50, the fiber layer 50 is tensioned against the contour of the shell 10, so as to provide the desired elastic counterforce or resilience in response to an external force acting on the shell 10. This allows the resulting helmet to be made thin and light through simplified operation while having good structural strength. In addition, the complementarity in terms of structural strength between the shell 10 and the fiber layer 50 allows the resulting helmet to be made with reduced thickness, weight and volume.

3. Particularly, the disclosed method helps to minimize misalignment or mismatch between edges of the graphic piece or the fabric material and the contour of the plastic shell, and thus addresses the problems of the conventional safety helmets about unevenness or creases caused by poor adhesion of the graphic piece or the fabric material, time-consuming processing or fabrication, high demands for and dependency on skilled workers, high defective loss and high material costs.

Thus, the present invention provides an effective method for fabricating a strengthened plastic shell of a safety helmet and a helmet structure fabricated using the method. The resulting safety helmet has a spatial configuration that is different from the conventional ones, and thereby has significant improvements and advantages over the prior art, making it a patent-worthy invention.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A method for fabricating a strengthened plastic shell of a safety helmet, comprising:
a process (A), providing at least one fiber layer (50) and at least one shell (10) that has a thin, flat structure, in which each of the fiber layer (50) and the shell (10) has a first side (51, 11) and a second side (52, 12);
a process (B), binding the first side (51) of the fiber layer (50) to the second side (12) of the shell (10) to form a preform (40); and
a process (C), heating and pressing the preform (40) with a first forming module (60), so that at least some local, surface texture of the shell (10) is fused with or interlaced with the fiber layer (50) to make the preform (40) bonded and united, and thereby forming an assembly (99) that has a helmet-like shape.

2. The method for fabricating a strengthened plastic shell of a safety helmet as claimed in claim 1, wherein the process (C) is followed by a process (D), which comprises arranging a foam material at an inner surface of the assembly (99) and foaming the foam material into an elastic structure (30) attached over the inner surface of the assembly (99) using a second forming module (65), thereby forming a helmet structure (100).

3. The method for fabricating a strengthened plastic shell of a safety helmet as claimed in claim 1, wherein in the process (B), the preform (40) is further pressed by a module (45) so as to attach the fiber layer (50) to the shell (10) firmly.

4. The method for fabricating a strengthened plastic shell of a safety helmet as claimed in claim 2, wherein in the process (B), the preform (40) is further pressed by a module (45) so as to attach the fiber layer (50) to the shell (10) firmly.

5. The method for fabricating a strengthened plastic shell of a safety helmet as claimed in claim 1, wherein in the process (B), an adhesive (44) is arranged between the first side (51) of the fiber layer and the second side (12) of the shell so as to attach the fiber layer (50) to the shell (10) firmly.

6. The method for fabricating a strengthened plastic shell of a safety helmet as claimed in claim 2, wherein in the process (B), an adhesive (44) is arranged between the first side (51) of the fiber layer and the second side (12) of the shell so as to attach the fiber layer (50) to the shell (10) firmly.

7. The method for fabricating a strengthened plastic shell of a safety helmet as claimed in claim 1, wherein in the process (C), when the surface texture of the shell (10) in interlaced with the fiber layer (50), structural texture of the fiber layer (50) is expanded, so that the fiber layer (50) is tensioned against a surface contour of the shell (10).

8. The method for fabricating a strengthened plastic shell of a safety helmet as claimed in claim 2, wherein in the process (C), when the surface texture of the shell (10) in interlaced with the fiber layer (50), structural texture of the fiber layer (50) is expanded, so that the fiber layer (50) is tensioned against a surface contour of the shell (10).

9. The method for fabricating a strengthened plastic shell of a safety helmet as claimed in claim 3, wherein in the process (C), when the surface texture of the shell (10) in interlaced with the fiber layer (50), structural texture of the fiber layer (50) is expanded, so that the fiber layer (50) is tensioned against a surface contour of the shell (10).

10. The method for fabricating a strengthened plastic shell of a safety helmet as claimed in claim 4, wherein in the process (C), when the surface texture of the shell (10) in interlaced with the fiber layer (50), structural texture of the fiber layer (50) is expanded, so that the fiber layer (50) is tensioned against a surface contour of the shell (10).

11. The method for fabricating a strengthened plastic shell of a safety helmet as claimed in claim 5, wherein in the process (C), when the surface texture of the shell (10) in interlaced with the fiber layer (50), structural texture of the fiber layer (50) is expanded, so that the fiber layer (50) is tensioned against a surface contour of the shell (10).

12. The method for fabricating a strengthened plastic shell of a safety helmet as claimed in claim 6, wherein in the process (C), when the surface texture of the shell (10) in interlaced with the fiber layer (50), structural texture of the fiber layer (50) is expanded, so that the fiber layer (50) is tensioned against a surface contour of the shell (10).

13. The method for fabricating a strengthened plastic shell of a safety helmet as claimed in claim 1, wherein the shell (10) is made of a plate having a thickness of 0.5 mm˜2.0 mm.

14. The method for fabricating a strengthened plastic shell of a safety helmet as claimed in claim 7, wherein the shell (10) is made of a plate having a thickness of 0.5 mm˜2.0 mm.

15. The method for fabricating a strengthened plastic shell of a safety helmet as claimed in claim 8, wherein the shell (10) is made of a plate having a thickness of 0.5 mm˜2.0 mm.

16. A helmet structure fabricated using the method as claimed in claim 1, the helmet structure comprising:
a combination of the shell (10) and the fiber layer (50) deposited on the shell (10);
wherein the shell (10) has at least its local, surface texture interlaced within the fiber layer (50) so that the shell (10) and the fiber layer (50) are bonded and united.

17. The helmet structure as claimed in claim 16, wherein the fiber layer (50) is made by putting a plurality of fiber pieces together into the complete fiber layer (50).

18. The helmet structure as claimed in claim 16, wherein the shell (10) is made by putting a plurality of flat plates together into the complete shell (10).

19. The helmet structure as claimed in claim 17, wherein the shell (10) is made by putting a plurality of flat plates together into the complete shell (10).

20. The helmet structure as claimed in claim 16, wherein the fiber layer (50) is tensioned against a surface contour of the shell (10), and an elastic structure (30) made of a foam material is attached to an inner surface of the shell (10), so that the fiber layer (50), the shell (10) and the elastic structure (30) jointly form a helmet structure (100).

21. The helmet structure as claimed in claim 17, wherein the fiber layer (50) is tensioned against a surface contour of the shell (10), and an elastic structure (30) made of a foam material is attached to an inner surface of the shell (10), so that the fiber layer (50), the shell (10) and the elastic structure (30) jointly form a helmet structure (100).

22. The helmet structure as claimed in claim 18, wherein the fiber layer (50) is tensioned against a surface contour of the shell (10), and an elastic structure (30) made of a foam material is attached to an inner surface of the shell (10), so that the fiber layer (50), the shell (10) and the elastic structure (30) jointly form a helmet structure (100).

23. The helmet structure as claimed in claim 19, wherein the fiber layer (50) is tensioned against a surface contour of the shell (10), and an elastic structure (30) made of a foam material is attached to an inner surface of the shell (10), so that the fiber layer (50), the shell (10) and the elastic structure (30) jointly form a helmet structure (100).
